(19) United States
(12) Patent Application Publication
(10) Pub. No.: US 2014/0262499 A1
(43) Pub. Date: Sep. 18, 2014

(54) METHODS AND APPARATUS FOR OPTIMIZING ELECTRICALLY INOPERATIVE ZONES ON LAMINATED COMPOSITE ASSEMBLIES

(71) Applicant: BOULDER WIND POWER, INC., Louisville, CO (US)

(72) Inventors: James S. Smith, Lyons, CO (US); James D. Duford, Polson, MT (US); Stephane Eisen, Louisville, CO (US); James D. Jore, Polson, MT (US); Brian Sullivan, Boulder, CO (US)

(73) Assignee: Boulder Wind Power, Inc., Louisville, CO (US)

(21) Appl. No.: 13/804,575

(22) Filed: Mar. 14, 2013

(51) Int. Cl. H01B 5/00; H01R 4/00

(52) U.S. Cl. CPC H01B 5/002; H01R 4/00
USPC 174/84 R; 174/126.2

(57) ABSTRACT

In some embodiments, a system includes a first portion, a second portion, and a third portion of an electrical conductor. Each portion is electrically coupled to the other two portions. The first, second, and third portions are configured such that substantially no current induced in and/or supplied to the first portion is conducted to the third portion of the electrical conductor. The third portion of the electrical conductor is also thermally coupled to the first and second portions of the electrical conductor. The third portion of the electrical conductor is configured to transfer thermal energy from the first portion of the electrical conductor to an edge portion of the laminated composite assembly.

### BACKGROUND

This invention relates to systems and methods for optimizing electrically inoperative zones on laminated composite assemblies.

Some known laminated composite assemblies can include conductive material in electrically inoperative zones. Electrical currents are generated in conductive materials when the conductive materials are exposed to alternating magnetic fields. Thus, a laminated composite assembly that includes conductive material in electrically inoperative zones can experience induced eddy currents in those electrically inoperative zones when the laminated composite assembly is exposed to an alternating magnetic field. The eddy currents in the electrically inoperative zones generate resistive losses and heating without providing useful output.

Further, an operating laminated composite assembly generates thermal energy in both the electrically operative and electrically inoperative zones. Thermal energy can increase the operating temperature of the laminated composite assembly, thus reducing its efficiency and/or causing a failure if the operating temperature exceeds the limits of the laminated composite assembly. Thermal energy generated in electrically inoperative zones is often ignored, reducing the overall efficiency of the laminated composite assembly.

Thus, a need exists for improved systems and methods of optimizing electrically inoperative zones on laminated composite assemblies.

### SUMMARY

In some embodiments, a system includes a first portion, a second portion, and a third portion of an electrical conductor. Each portion is electrically coupled to the other two portions. The first, second, and third portions are configured such that substantially no current induced in and/or supplied to the first portion is conducted to the third portion of the electrical conductor. The third portion of the electrical conductor is also thermally coupled to the first and second portions of the electrical conductor. The third portion of the electrical conductor is configured to transfer thermal energy from the first portion of the electrical conductor to an edge portion of the composite assembly.

### BRIEF DESCRIPTION OF THE DRAWINGS

FIG. 1 illustrates a laminated composite assembly having a first portion, a second portion, and a third portion of an electrical conductor, according to an embodiment.

FIG. 2A illustrates a first layer of the laminated composite assembly of FIG. 1.

FIG. 2B illustrates a second layer of the laminated composite assembly of FIG. 1.

FIG. 3 illustrates a schematic view of a laminated composite assembly having an electrical interconnect and an electrical conductor having a first, second, and third portion, according to an embodiment.

FIGS. 4-5 illustrate laminated composite assemblies each having a first conductor and a second, electrically inoperative conductor, according to other embodiments.

FIG. 6 illustrates a cross-sectional view of a laminated composite assembly having an electrical interconnect, according to an embodiment.

FIG. 7 illustrates a cross-sectional view of a motor with a stator having a laminated composite assembly, according to an embodiment.

FIG. 8A illustrates a laminated composite assembly having an electrical conductor with a first portion, a second portion, and a third portion, according to another embodiment.

FIG. 8B illustrates a close-up view of the second portion of the conductor of FIG. 8A.

### DETAILED DESCRIPTION

In some embodiments, a system includes at least three portions of an electrical conductor of a laminated composite assembly. Each portion of the electrical conductor is electrically coupled to the other two portions of the electrical conductor. The three portions are configured such that substantially no current provided to (e.g., induced in and/or supplied to) the first portion of the electrical conductor is conducted to the third portion of the electrical conductor. The third portion of the electrical conductor is also thermally coupled to the other two portions of the electrical conductor. The third portion of the electrical conductor can be configured to transfer thermal energy from the first portion of the electrical conductor to an edge portion of the laminated composite assembly. Conducting the thermal energy from an inner portion of the laminated composite assembly to an edge portion can allow the heat generated within the laminated composite assembly to be conducted to cooler portions of the laminated composite assembly, to be conducted to a heat sink, and/or to dissipate in the atmosphere. This can lower the operating temperature of the laminated composite assembly as compared to the laminated composite assembly without a third portion configured to conduct thermal energy to an edge portion of the laminated composite assembly.

In some embodiments, a system includes a first conductor of a laminated composite assembly and multiple second conductors of the laminated composite assembly. The first conductor is electrically operative, and the multiple second conductors are each electrically inoperative. The multiple second conductors can each be electrically isolated from the first conductor and the other multiple second conductors. Isolating the multiple second conductors can substantially reduce the formation of eddy currents on the multiple second conductors. Because circulating eddy currents within conductors can generate resistive losses and heating, this design can reduce resistive losses and heating, resulting in a more efficient laminated composite assembly design.

In some embodiments, a system includes a laminated composite assembly with two surface layers and at least one inner layer disposed between the two surface layers. The inner layer includes at least one conductor having an electrical interconnect that thermally couples the conductor to at least a portion of each of the two surface layers. The thermal energy at the conductor of the inner layer can be transferred via the electrical interconnect to the two surface layers, allowing the designer to achieve a predetermined thermal profile.

As used herein, the term “electrically operative” refers to a conductor that can be electrically coupled to a closed electric circuit such that the electrically operative conductor can conduct useful current as part of a closed electric circuit. For example, a stator winding, a power bus, and/or any other conductor that conducts useful current can be electrically operative.

As used herein, the term “electrically inoperative” refers to a conductor that does not conduct useful current. While an electrically inoperative conductor can conduct current, such as eddy current, an electrically inoperative conductor does not conduct current through a closed electric circuit. For example, a conductor having one or more ends that are not electrically coupled to an electrically operative portion of a circuit (e.g., an electrical component, a closed circuit, or ground) is electrically inoperative because substantially no useful current flows through the conductor, even if a second end of the conductor is electrically coupled to a closed circuit. Similarly stated, a conductor with two ends where one end is electrically coupled to a closed electric circuit and the second end is not electrically coupled to an electrically operative portion of a circuit (e.g., that end is open or coupled to a heat sink) conducts substantially no useful current. Another example of an electrically inoperative conductor is an electrically isolated conductor. Similarly stated, a conductor not electrically coupled to any other conductor or circuit is electrically inoperative. Eddy currents can be induced in conductors, including electrically inoperative conductors.

FIG. 1 is an illustration of a portion of a laminated composite assembly 100 having an electrical conductor 145 with a first portion 105, a second portion 110, and a third portion 115. Laminated composite assembly 100 can be used to support a portion of an electric circuit including the electrical conductor 145. For example, the portion of laminated composite assembly 100 can be a portion of an integrated circuit (“IC”), a printed circuit board (“PCB”), a PCB assembly, an application-specific integrated circuit (“ASIC”), or any other electric circuit support structure.

Laminated composite assembly can include one or more layers, a first edge portion 140, a second edge portion 155, and a conductor 145. A layer can include one or more conductors and one or more electrical interconnects.

Each layer can include one or more conductors disposed on a surface of a core that separates that layer from another layer on an opposite surface of the core. In some embodiments a layer on a core can be separated from a layer on another core by an insulator (e.g., a prepreg dielectric material). Thus, each layer can be separated by a dielectric material or a core that electrically isolates the conductor on that layer from the conductors on the other layers. A conductor on a first layer can be electrically coupled and/or thermally coupled to a conductor on a second layer using an electrical interconnect (i.e., electrical interconnects 150), such as, for example, a via. Layers of a laminated composite assembly are described in more detail with respect to FIGS. 3 and 6.

FIG. 2A is an illustration of a first layer 200 of laminated composite assembly 100, and FIG. 2B is an illustration of a second layer 250 of laminated composite assembly 100. While laminated composite assembly 100 is shown in FIG. 1 as having multiple layers, a laminated composite assembly 100 can have any number of layers, including a single layer. In a single layer embodiment, the first portion 105, the second portion 110, and the third portion 115 can each be on the single layer.

The layers of laminated composite assembly 100 can include internal bus bar conductors, power distribution conductors, end turns of a stator coil, windings of a stator coil, signal conductors, power conductors, and/or any other appropriate conductor. Additionally, a layer can include multiple types of conductors. For example, a layer can include an internal bus bar conductor and a power distribution conductor.

In some embodiments, conductor 145, including the first portion 105, second portion 110, and third portion 115 can be copper, silver, aluminum, gold, zinc, tin, tungsten, graphite, conductive polymer, and/or any other suitable conductive material. Conductor 145 can form part of the circuit of laminated composite assembly 100. In a circuit, a conductor can be used to electrically couple components and allow the flow of current through the circuit. When, however, multiple layers are used in a laminated composite assembly, conductors on each layer are generally not electrically coupled to each other unless some form of electrical interconnect is used because the cores and insulators are generally non-conductive materials.

Conductor 145 can be electrically operative or electrically inoperative. In some embodiments, a portion of conductor 145 can be electrically operative while another portion of conductor 145 can be electrically inoperative. Similarly stated, an electrically inoperative portion of conductor 145 does not render the entire conductor 145 electrically inoperative.

Conductor 145, whether electrically operative or electrically inoperative, can also conduct thermal energy. Conducting thermal energy can allow heat to flow to cooler areas of laminated composite assembly 100. For example, heat can flow from an inner portion of the laminated composite assembly 100 to an edge portion 130, depending on the configuration of conductor 145.

Laminated composite assembly 100 can also include one or more electrical interconnects 150. Electrical interconnects are described in further detail in U.S. patent application Ser. No. 13/778,415 entitled “METHODS AND APPARATUS FOR OPTIMIZING ELECTRICAL INTERCONNECTS ON LAMINATED COMPOSITE ASSEMBLIES,” filed Feb. 27, 2013, which is incorporated herein by reference in its entirety.

As mentioned above, electrical interconnects 150 electrically couple the layers of laminated composite assembly 100. Electrical interconnects 150 can each be a solid electrical interconnect, a pressed pin, a plated electrical interconnect that defines a lumen, and/or any other connection capable of electrically coupling layers of laminated composite assembly 100. In the case that an electrical interconnect 150 defines a lumen, the lumen can remain empty (e.g., a cavity having air), be filled with a non-conductive material, or be filled with a conductive material. In some embodiments, each electrical interconnect 150 can be the same (e.g., each are a pressed pin) or different (e.g., a first electrical interconnect 150 is a plated electrical interconnect that defines a lumen filled with non-conductive material and a second electrical interconnect 150 is a pressed pin).

In some embodiments, electrical interconnects 150 can be circular in shape as shown in FIG. 1. In other embodiments, electrical interconnects 150 can be square, triangle, star, diamond, irregular, and/or any other suitable shape. Additionally, while FIG. 1 shows the electrical interconnects 150 as each the same shape as the others, in other embodiments, electrical interconnects 150 can be different shapes.

Electrical interconnects 150 can electrically couple any number of layers of laminated composite assembly 100. In some embodiments, a first electrical interconnect 150 can electrically couple the same layers as a second electrical interconnect 150, different layers than a second electrical interconnect 150, or some of the same layers as a second electrical interconnect 150. Furthermore, electrical interconnects 150 can electrically couple portions of one or more conductors, including conductor 145, on different layers that perform different functions within the laminated composite assembly 100. For example, electrical interconnects 150 can electrically couple a power distribution conductor to an internal bus bar conductor and/or an end turn of a stator coil. Electrical interconnects 150 can also couple an electrically operative portion of a conductor to an electrically inoperative portion of a conductor on a different layer.

Electrical interconnects 150 can conduct thermal energy. Similarly stated, electrical interconnects 150 thermally couple conductors on different layers. Conducting thermal energy through electrical interconnects 150 can allow heat to flow between portions of conductor 145 on different layers of laminated composite assembly 100. For example, heat can flow from an inner layer to a surface layer of laminated composite assembly 100, depending on the configuration of electrical interconnects 150.

In some embodiments, the first portion 105 of conductor 145 can be electrically operative. For example, the first portion 105 of conductor 145 can be an electrically operative portion of a conductor of a stator in a motor or generator (e.g., an operative portion in which current is induced). In some embodiments, the first portion 105 of conductor 145 can include an internal bus bar conductor, a power distribution conductor, an end turn of a stator coil, a winding of a stator coil, a signal conductor, a power conductor, and/or any other electrically operative portion of a circuit.

The first portion 105 of conductor 145 can be disposed on every layer of laminated composite assembly 100. In some embodiments, however, the first portion 105 of conductor 145 can be disposed on fewer than every layer of laminated composite assembly 100. For example, the first portion 105 of conductor 145 in FIGS. 1, 2A, and 2B is shown on both the first layer 200 and the second layer 250 of laminated composite assembly 100. In some embodiments, the remaining layers can each include the first portion 105, some of the remaining layers can include the first portion 105, or no other layers include the first portion 105.

The first portion 105 of the electrical conductor 145 can include an end portion 120, as shown in FIGS. 1, 2A, and 2B. The end portion 120 of the first portion 105 of conductor 145 can be disposed at a portion of laminated composite assembly 100 that is not an edge portion 140, 155 of laminated composite assembly 100. Similarly stated, the end portion 120 of the first portion 105 of conductor 145 can be disposed at an inner portion of laminated composite assembly 100. In some embodiments, the first portion 105 of conductor 145 can include multiple end portions (not shown in FIG. 1, 2A, or 2B).

In some embodiments, the first portion 105 of conductor 145 can be positioned substantially parallel to a first edge portion 140 of laminated composite assembly 100. As shown in FIGS. 1, 2A, and 2B, the first portion 105 can be substantially linear and/or straight. In other embodiments, the first portion 105 can be disposed on a core such that the first portion 105 is arced, angled, curved, turned, or any other suitable configuration.

In some embodiments, the second portion 110 of conductor 145 can be electrically operative. For example, the second portion 110 of conductor 145 can be an electrically operative portion of a stator winding of a motor or generator (e.g., an end turn section). Similarly stated, the second portion 110 of conductor 145 can be electrically coupled to another portion of a closed electric circuit such that the second portion is not open on one or more end portions. In some embodiments, the second portion 110 of conductor 145 can include an internal bus bar conductor, a power distribution conductor, an end turn of a stator coil, a winding of a stator coil, a signal conductor, a power conductor, and/or any other electrically operative portion of a circuit.

The second portion 110 of conductor 145 can include an end portion 125, as shown in FIGS. 1 and 2A. The end portion 125 of the second portion 110 of conductor 145 can be disposed at a portion of laminated composite assembly 100 that is not an edge portion 140, 155 of laminated composite assembly 100. Similarly stated, the end portion 125 of the second portion 110 of conductor 145 can be disposed at an inner portion of laminated composite assembly 100. In some embodiments, the second portion 110 of conductor 145 can include multiple end portions (not shown in FIG. 1, 2A, or 2B).

As shown in FIGS. 1 and 2A, the second portion 110 of conductor 145 can form an arc. In other embodiments, the second portion 110 of conductor 145 can form any shape or configuration.

The second portion 110 of conductor 145 is shown in FIGS. 1 and 2A on the first layer 200 of laminated composite assembly 100. In some embodiments, the second portion 110 of conductor 145 can be disposed on a different layer and/or on multiple layers of laminated composite assembly 100.

In some embodiments, the third portion 115 of conductor 145 can be electrically inoperative. For example, as shown in FIG. 1, the second end portion 135 of the third portion 115 of conductor 145 can terminate without being electrically coupled to another portion of conductor 145 or any part of a closed circuit. Similarly stated, the second end portion 135 of the third portion 115 of conductor 145 can be open. Stated yet another way, the second end portion 135 of the third portion 115 of conductor 145 can be configured such that the third portion 115 of conductor 145 is not a closed loop portion of a closed circuit. In some embodiments, the second end portion 135 of the third portion 115 can be thermally coupled to a heat sink and/or any other suitable heat dissipating element. In some embodiments, the second end portion 135 of the third portion 115 can be at a second edge portion 155 of laminated composite assembly 100. Because the second end portion 135 of the third portion 115 of conductor 145 can be open, substantially no useful current flows on the third portion 115 of conductor 145, rendering the third portion 115 of conductor 145 electrically inoperative. The third portion 115 of conductor 145 can include multiple end portions 130, 135, as shown in FIGS. 1 and 2B. As described above, the second end portion 135 of the third portion 115 can be disposed at a second edge portion 155 of laminated composite assembly 100. The first end portion 130 of the third portion 115 of conductor 145 can be disposed at a portion of laminated composite assembly 100 that is not an edge portion 140, 155 of laminated composite assembly 100. Similarly stated, the first end portion 130 of the third portion 115 of conductor 145 can be disposed at an inner portion of laminated composite assembly 100.

As shown in FIGS. 1 and 2B, the third portion 115 of conductor 145 can be substantially parallel to a first edge portion 140 of laminated composite assembly 100. While shown in FIGS. 1 and 2B as substantially linear and/or straight, the third portion 115 of conductor 145 can be any other suitable configuration.

In some embodiments, the third portion 115 of conductor 145 can be disposed on a second layer 250 of laminated composite assembly 100, as shown in FIG. 2B. In some embodiments, the third portion 115 of conductor 145 can be disposed on multiple layers and/or a different layer than the second layer 250.

FIG. 2A illustrates a first layer 200 of laminated composite assembly, including the first portion 105 and the second portion 110 of conductor 145. The end portion 120 of the first portion 105 of conductor 145 and the end portion 125 of the second portion 110 of conductor 145 can intersect and/or meet at reference line A. The first portion 105 and the second portion 110 of conductor 145 can be electrically and/or thermally coupled by a continuation of the conductor trace.

While depicted in FIGS. 1 and 2A as disposed on a first layer 200, the first portion 105 and the second portion 110 of conductor 145 can be disposed on any layer. Also, as discussed above, the first portion 105 and/or the second portion 110 can be disposed on multiple layers.

In other embodiments, the first portion of the conductor can be disposed on one or more different layers than the second portion of the conductor and/or on some of the same and some different layers than the second portion of the conductor. In such embodiments, the first portion of the conductor can be electrically and/or thermally coupled to the second portion of the conductor using one or more electrical interconnects.

As shown in FIG. 2B, the first portion 105 of conductor 145 (which is disposed on both the first layer 200 and the second layer 250) can be disposed on the same layer as the third portion 115 of conductor 145. The end portion 120 of the first portion 105 of conductor 145 can be electrically and/or thermally coupled to the end portion 135 of the third portion 115 of conductor 145 at reference line A by a continuation of the conductor trace.

While depicted in FIGS. 1 and 2B as disposed on the second layer 250, the first portion 105 and the third portion 115 of conductor 145 can be disposed on any layer. Also, as discussed above, the first portion 105 and/or the third portion 115 of conductor 145 can be disposed on multiple layers

In other embodiments, the first portion of the conductor can be disposed on one or more different layers than the third portion of the conductor and/or on some of the same and some different layers than the third portion of the conductor. In such embodiments, the first portion of the conductor can be electrically and/or thermally coupled to the third portion of the conductor using one or more electrical interconnects.

In some embodiments the second portion 110 and the third portion 115 of conductor 145 can be disposed on different layers, as shown in FIGS. 2A and 2B. The end portion 125 of the second portion 110 and the first end portion 130 of the third portion 115 of conductor 145 can be electrically and/or thermally coupled by electrical interconnects 150.

In some embodiments, the second portion 110 and the third portion 115 of conductor 145 can be disposed on different layers that are separated by multiple other layers. In such embodiments, the second portion 110 and the third portion 115 of conductor 145 can nonetheless be electrically and/or thermally coupled using electrical interconnects 150.

In some embodiments, the second portion and the third portion of the conductor can be disposed on the same layer. In such embodiments the second portion of the conductor can be electrically and/or thermally coupled to the third portion of the conductor by a continuation of the conductor trace. Additionally, while shown in FIGS. 1 and 2B with the second portion 110 of conductor 145 on the first layer 200 and the third portion 115 of conductor 145 on the second layer 250, the second portion 110 and the third portion 115 of conductor 145 can be disposed on any layer and/or on multiple layers.

In addition to being electrically and/or thermally coupled together, the first portion 105, the second portion 110, and the third portion 115 of conductor 145 can be electrically and/or thermally coupled to one or more other portions of conductor 145 and/or one or more other electrical conductors.

As discussed above, a conductor can conduct both current and thermal energy. An electrical coupling, including by continuation of the conductor trace or by an electrical interconnect, can function as both a thermal coupling and an electrical coupling. Similarly stated, an electrical interconnect and a conductor can each conduct current and thermal energy.

In use, current can be provided to (e.g., induced in and/or supplied to) the first portion 105 of conductor 145. Current “I₁” can flow in the direction shown in FIG. 1. At reference line A, the end portion 120 of the first portion 105 of conductor 145 can be electrically coupled to the end portion 125 of the second portion 110 and third portion 115 of conductor 145 as described above. In some embodiments, current “I₁” can flow from the first portion 105 of conductor 145 into the second portion 110 of conductor 145, and the current “I₂” can flow in the direction shown. The current “I₂” can substantially equal current “I₁.” In some embodiments, laminated composite assembly 100 can be configured such that substantially no current “I₁” induced in and/or supplied to the first portion 105 of conductor 145 is conducted to the third portion 115 of conductor 145. For example, as shown in FIG. 1, substantially no current “I₁” flows from the end portion 120 of the first portion 105 of conductor 145 into the first end portion 130 of the third portion 115 of conductor 145 because the third portion 115 of conductor 145 represents an open circuit, as discussed above.

Currents “I₁” and “I₂” can generate thermal energy within laminated composite assembly 100. Thermal energy can be transferred through a conductor and/or or through an electrical interconnect. Thermal energy typically flows in the direction that leads to a cooler temperature. Because the ambient air temperature near an operating laminated composite assembly is generally cooler than the temperature on the conductor within a laminated composite assembly, the thermal energy at an inner portion of a laminated composite assembly can flow on a conductor to an edge portion of the laminated composite assembly to dissipate into ambient air. For example, as thermal energy is generated in and conducted through the first portion 105 of conductor 145, at reference line A, the thermal energy can conduct to the third portion 115 of the electrical conductor 145, and flow to the second edge portion 155 of laminated composite assembly 100.

While shown and described with respect to FIG. 1 as being direct current (“DC”), in other embodiments, alternating current (“AC”) can be used. For example, in AC embodiments, initially current “I₁” and “I₂” can flow in the direction shown in FIG. 1. Then the current can alternate to flow in the opposite direction. The current can continue to alternate direction back and forth at a frequency.

In such embodiments, the current “I₂” from the second portion 110 of conductor 145 can flow to the first portion 105 of conductor 145 when flowing in the opposite direction shown. As described above, current “I₂” will substantially not flow into the third portion 115 of conductor 145 because the third portion 115 of conductor 145 is electrically inoperative. The thermal energy from the second portion 110 of conductor 145 can flow through electrical interconnects 150 to the third portion 115 of conductor 145 and to the second edge portion 155 of laminated composite assembly 100.

FIG. 3 is a schematic view of a portion of laminated composite assembly 300 having an electrical interconnect 340, an input 370, an output 380, multiple layers 350, 352, 354, 356, 358, 360, 362, 364, and an electrical conductor 390 with a first portion 310, a second portion 320, and a third portion 330. Laminated composite assembly 300 can be structurally and functionally similar to laminated composite assembly 100.

As shown in FIG. 3, laminated composite assembly 300 can include an electrical interconnects 340, 342, 344, which are structurally and functionally similar to electrical interconnects 150 (FIG. 1). While three electrical interconnects 340, 342, 344 are shown, laminated composite assembly 300 can include greater or fewer than three electrical interconnects. Additionally, while electrical interconnect 340 is shown as coupling the first layer 350 through the eighth layer 364, electrical interconnect 340 can couple fewer conductors than conductors on every layer of laminated composite assembly 300. As described above, electrical interconnects 340, 342, 344 can electrically and/or thermally couple conductors on the layers of laminated composite assembly 300.

Electrical interconnect 342 can electrically and/or thermally couple layers that include the first portion 310 of laminated composite assembly 300. For example, the first layer 350, the third layer 354, the fourth layer 356, the sixth layer 360, and the eighth layer 364. Coupling layers that include the first portion 310 with electrical interconnect 342 can allow a current (e.g., supplied from “I₁”) to flow to the layers that include the first portion 310.

Electrical interconnect 344 can electrically and/or thermally couple layers that include the second portion 320 of laminated composite assembly 300. Coupling the layers that include the second portion 320 can allow current (e.g., supplied from “I₁”) from the layers that include the second portion 320 to collect on a single layer (i.e., the eighth layer 364) and current “I₂” to exit at output 380.

Input 370 can be an entry point for current into laminated composite assembly 300. The input current “I₁” can be from a current source, another portion of laminated composite assembly 300, another laminated composite assembly, or any other suitable input. While shown in FIG. 3 as being a single input 370 residing on and/or coupled to a single layer (e.g., the eighth layer 364), in other embodiments the input can include multiple inputs electrically coupled to multiple layers.

Output 380 can be an exit point for current out of laminated composite assembly 300. Output current “I₂” can go to a power grid, another portion of laminated composite assembly 300, another laminated composite assembly, or any other suitable output. While shown in FIG. 3 as being a single output 380 residing on and/or coupled to a single layer (e.g., the eighth layer 364), in other embodiments the output can include multiple outputs electrically coupled to multiple layers.

Laminated composite assembly 300 can include multiple layers, as shown in FIG. 3. While not depicted in this schematic view, the first through eighth conductive layers 350, 352, 354, 356, 358, 360, 362, 364 can each be separated from the other layers by a dielectric material, including a core or an insulator. FIG. 6 describes cores, insulators, and layers in more detail.

Layers can include one or more portions of an electrical conductor and a portion of one or more electrical interconnects. For example, the first layer 350 includes the first portion 310 and the third portion 330 of conductor 390, while the second layer 252 includes only the second portion 320 of conductor 390. Each layer includes a portion of electrical interconnect 340.

In some embodiments, the first portion 310 of conductor 390 can be electrically operative and can be used to electrically couple components and allow current to flow through a circuit. For example, as depicted in FIG. 3, the first portion 310 of conductor 390 can allow current “I₁” to flow in the direction shown through laminated composite assembly 300.

In some embodiments, the second portion 320 of conductor 390 can be electrically operative and can be used to electrically couple components and allow current to flow through a circuit. For example, as seen in FIG. 3, the second portion 320 of conductor 390 can allow a current (e.g., supplied from the first portion) to flow in the direction shown through laminated composite assembly 300 from electrical interconnect 340 to electrical interconnect 344.

The third portion 330 of conductor 390, in some embodiments, can be electrically inoperative. For example, as seen in FIG. 3, the third portion 330 of conductor 390 can conduct substantially no useful current because the third portion 330 of conductor 390 represents an open circuit. Similarly stated, in FIG. 3, the second end portion 332 of the third portion 330 is not electrically coupled to a closed circuit such that the third portion 330 can conduct substantially no useful current.

The first portion 310, the second portion 320, and the third portion 330 of conductor 390 can be electrically and/or thermally coupled to the other portions of conductor 390 on the different layers using electrical interconnect 340. On layers with multiple portions, the end portions can be electrically and/or thermally coupled by a continuation of the conductor trace. For example, the fourth layer 356 can include the first portion 310 and the third portion 330 of conductor 390. On the fourth layer, the first portion 310 of conductor 390 can be electrically and/or thermally coupled to the third portion 330 of conductor 390 by continuing the conductor trace from the end portion 315 of the first portion 310 to the first end portion 334 of the third portion 330 of conductor 390.

The first portion 310 of conductor 390 is depicted in FIG. 3 as disposed on the first, third, fourth, sixth, and eighth layers 350, 354, 356, 360, 364, the second portion 320 of conductor 390 is depicted as disposed on the second and third layers 352, 354, and the third portion 330 of conductor 390 is depicted as disposed on the first, fourth, fifth, seventh, and eighth layers 350, 356, 358, 362, 364. In some embodiments, however, the first portion 310, the second portion 320, and the third portion 330 of conductor 390 can be disposed on greater or fewer layers of laminated composite assembly 300 and/or on different layers than depicted in FIG. 3.

In use, current “I₁” can be induced in and/or supplied to laminated composite assembly 300 at input 370. Current “I₁” can flow through electrical interconnect 342 to the first layer 350, the third layer 354, the fourth layer 356, and the sixth layer 360. Some current (i.e., from “I₁”) can flow on the conductor on the eighth layer 364. The current (i.e., from “I₁”) can flow through the first portion 310 on the different layers to electrical interconnect 340. At electrical interconnect 340, the current (i.e., from “I₁”) can flow through electrical interconnect 340 to other layers of laminated composite assembly 300. For example, the current (i.e., from “I₁”) can flow through the first portion 310 of conductor 390 on the first, third, fourth, sixth, and eighth layers 350, 354, 356, 360, and 364. At electrical interconnect 340, substantially no current flows through electrical interconnect 340 to the third portion 330 of conductor 390 because the third portion 330 of conductor 390 is not electrically coupled to an electrical component or electrically operative conductor at the second end portion 332. At electrical interconnect 340, however, current (i.e., supplied from the first portion) can flow through electrical interconnect 340 to the second portion 320 of conductor 390 on the second layer 352, the third layer 354, and the eighth layer 364. At electrical interconnect 344, current (i.e., supplied from the second portion) can flow through electrical interconnect 344 and collect at output 380. Current “I₂” can exit the second portion 320 of conductor 390 at output 380, as shown in FIG. 3. Current “I₂” can be substantially the same as current “I₁.”

Current in laminated composite assembly 300 can generate thermal energy, which can also flow on conductor 390. Thermal energy typically flows in a direction that leads to a cooler temperature. The third portion 330 of conductor 390 can be configured to promote thermal energy transfer. For example, the electrically uncoupled end of the third portion 330 of conductor 390 can terminate at an edge portion of composite assembly 300. As discussed in the description of FIG. 1, because the ambient air temperature near an operating laminated composite assembly is generally lower than the temperature on the conductor within a laminated composite assembly, the thermal energy at an inner portion of a laminated composite assembly can flow on the conductor to an edge portion of the laminated composite assembly to dissipate into ambient air. Similarly, the second end portion 332 of the third portion 330 of conductor 390 can be thermally coupled to a heat sink to promote thermal energy transfer to the heat sink.

FIG. 4 is an illustration of a portion of a layer of laminated composite assembly 400, having a first conductor 410 and multiple second conductors 420. The laminated composite assembly 400 can be used to support a portion of an electric circuit. For example, the portion of laminated composite assembly 400 can be a portion of an integrated circuit (“IC”), a printed circuit board (“PCB”), a PCB assembly, an application-specific integrated circuit (“ASIC”), or any other electric circuit support structure.

While only a single layer is shown in FIG. 4, laminated composite assembly 400 can have multiple layers. Layers of a laminated composite assembly are described in more detail with respect to FIG. 6.

In some embodiments, the conductors, including the first conductor 410 and the second conductors 420, can be copper, silver, aluminum, gold, zinc, tin, tungsten, graphite, conductive polymer, and/or any other suitable conductive material. Conductors can be used to electrically couple components and allow current to flow through a circuit. Conductors, or portions of conductors, can be electrically operative or electrically inoperative as described above.

The first conductor 410 can be electrically operative. For example, the first conductor 410 can be an end turn section of a stator winding in a motor or generator. In some embodiments, the first conductor 410 can include internal bus bar conductors, power distribution conductors, end turns of a stator coil, windings of a stator coil, signal conductors, power conductors, and/or any other electrically operative portion of a circuit. While shown in FIG. 4 as an arc, the first conductor 410 can be any suitable configuration.

The second conductors 420 can be electrically inoperative. For example, as shown in FIG. 4, the second conductors 420 can be multiple electrically isolated segments. The second conductors 420 can be electrically isolated from each other and from the first conductor 410. Because the second conductors 420 are each electrically isolated from any other electrical coupling, the second conductors 420 do not conduct useful current through a closed electric circuit.

Although the electrically isolated second conductors 420 are depicted in FIG. 4 as square in shape, the second conductors 420 can be any shape including circular, diamond, rectangle, star, irregular, and/or any other suitable shape. Furthermore, each second conductor 420 can be substantially the same shape as the other second conductors 420, can each be a different shape, and/or can be a combination thereof.

The second conductors 420 can be disposed on a core in a predetermined pattern, as shown in FIG. 4. In some embodiments, the second conductors 420 can be randomly distributed and not form a pattern.

In use, an alternating magnetic field can induce a current “I₄” in the first conductor 410 in the direction shown. The alternating magnetic field can also induce eddy currents in the second conductors 420.

Because, however, the second conductors 420 are separated into electrically isolated segments, the eddy currents can be substantially reduced. With large sections of electrically inoperative conductor, eddy currents can circulate, increasing the resistive and heat losses. Altering the size and/or shape of the second conductors 420 can further reduce eddy currents in the second conductors 420.

FIG. 5 is an illustration of a portion of a layer of laminated composite assembly 500, having an edge portion 530, a first conductor 510 and multiple second conductors 520. The laminated composite assembly 500 of FIG. 5 is structurally and functionally similar to the laminated composite assembly 400 of FIG. 4. The first conductor 510 is also structurally and functionally similar to the first conductor 410 of FIG. 4.

The second conductors 520 can be electrically inoperative. For example, as shown in FIG. 5, the second conductors 520 can be multiple electrically isolated segments. The second conductors 520 can be electrically isolated from each other and from the first conductor 510. Because the second conductors 420 are each electrically isolated from any other electrical coupling, the second conductors 420 do not conduct useful current through a closed electric circuit.

As shown in FIG. 5, the second conductors 520 can form a predetermined pattern. The second conductors 520 can be parallel strips that span from an electrically operative conductor (e.g., the first conductor 510) to an edge portion 530 of laminated composite assembly 500. While FIG. 5 depicts the second conductors 520 as evenly-spaced, uniform-width strips, the second conductors 520 can be unevenly-spaced and/or non-uniform width and/or non-parallel.

The second conductors 520 can have an end portion 540. The end portion 540 of the second conductors 520 can be at an edge portion 530 of laminated composite assembly 500. The end portion 540 of the second conductors 520 can terminate at the edge portion 530 of laminated composite assembly 500. In some embodiments, the end portion 540 of the second conductors 520 can be thermally coupled to a heat sink or other heat dissipating device.

In use, an alternating magnetic field can induce a current “I₅” in the first conductor 510 in the direction shown. The alternating magnetic field can also induce eddy currents in the second conductors 520. As described above, because the second conductors 520 are separated into electrically isolated segments, the eddy currents can be substantially reduced. Altering the size and/or shape of the second conductors 520 can further reduce eddy currents in the second conductors 520.

As discussed above, conductors can conduct thermal energy as well as current. In some embodiments, thermal energy generated in the laminated composite assembly 500 can be conducted to a cooler area of the laminated composite assembly 500 by one or more electrically inoperative conductors 520. For example, the thermal energy generated by the eddy currents in the second conductors 520 can flow on the second conductors 520 to the edge portion 530 of laminated composite assembly 500. As described above, the thermal energy transfer can be promoted by coupling the end portion 540 of the second conductors 520 to a heat sink or other heat dissipating device.

In some embodiments, multiple layers can be included in laminated composite assemblies 400, 500. One or more layers of laminated composite assembly 400, 500 can have electrically inoperative conductors that are functionally and structurally similar to the second conductors 420, 520. At least one second conductor can be electrically coupled to at least one other electrically inoperative conductor on a different layer using an electrical interconnect. Thermal energy can be transferred through the electrical interconnect from a conductor on a first layer to a conductor on a second layer. In some embodiments, the second conductors 420, 520 on an inner layer can be thermally coupled to the second conductors 420, 520 on a surface layer, allowing the thermal energy from the inner layer to flow through the electrical interconnect to the surface layer. Surface layers are generally a lower temperature than inner layers of a laminated composite assembly. Again, the thermal energy transfer can be promoted by thermally coupling the surface layer conductors to a heat sink or other heat dissipating device.

FIG. 6 is a cross sectional view of a laminated composite assembly 600 having multiple layers, multiple cores 630, multiple insulators 640, one or more conductors 610, and an electrical interconnect 620. Laminated composite assembly 600 can be structurally and functionally similar to laminated composite assembly 100 in FIG. 1.

Cores 630 can be made from any number of materials including fiberglass resin material, silicon, or any other suitable substrate dielectric material. In some embodiments, the core 630 of a layer can provide a base for conductors 610. For example, a PCB provides a base (e.g., core 630 of a PCB) for the conductors 610 etched on the PCB. While shown in FIG. 6 with conductors 610 on two surfaces of each core 630, a core 630 can have conductors 610 disposed on a single surface.

Insulators 640 can separate the layers of laminated composite assembly 600. Insulators 640 of laminated composite assembly 600 can be made from a dielectric material or any other suitable material that has poor or substantially no conductivity. Since they are poor conductors, insulators 640 can act as a shield between the conductive layers (e.g., conductors 610) of laminated composite assembly 600. Similarly stated, insulator 640 can substantially prevent current from flowing between the layers between which insulator 640 is located.

In some embodiments, conductors 610 can be copper, silver, aluminum, gold, zinc, tin, tungsten, graphite, conductive polymer, and/or any other suitable conductive material. Conductors 610 can be placed and/or etched on core 630, including being on one or more layers of laminated composite assembly 600. In some embodiments, conductors 610 can cover a portion of a core 630, the entirety of a core 630, a portion of a core 630 of one or more layers of laminated composite assembly 600, the entirety of a core 630 of one or more layers of laminated composite assembly 600, or any combination thereof.

Conductors 610 can form part of the circuit of laminated composite assembly 600. In a circuit, conductors 610 can be used to electrically couple components and allow the flow of current through the circuit. When, however, multiple layers are used in laminated composite assembly 600, conductors 610 on each layer are generally not electrically coupled to each other unless some form of electrical interconnect 620 is used because core 630 and insulator 640 are generally non-conductive materials.

The layers of laminated composite assembly 600 can include internal bus bar conductors, power distribution conductors, end turns of a stator coil, windings of a stator coil, signal conductors, power conductors, and/or any other appropriate conductor. Additionally, a single layer can include a plurality of types of conductors. For example, a single layer can include an internal bus bar conductor and a power distribution conductor.

In some embodiments, conductors 610 can be electrically inoperative, electrically operative, or a combination thereof. In some embodiments, the inner and/or surface layers of laminated composite assembly 600 can include layers similar to the layers described with respect to FIGS. 4 and 5. For example, an inner layer of laminated composite assembly can include a first conductor and a second conductor that can be electrically isolated from the first conductor. The first conductor and/or the second conductor can be electrically coupled to a current source. The second conductor can be electrically operative and the first conductor can be electrically inoperative.

Electrical interconnect 620 can allow the flow of electrical current through the circuit from a first layer of laminated composite assembly 600 to a second layer of laminated composite assembly 600. For example, electrical interconnect 620 can be a conductively-plated via that can electrically couple one or more conductors of different layers of laminated composite assembly 600. Electrical interconnect 620 can electrically couple one or more conductors on an inner layer of laminated composite assembly 600 to a conductor on a surface layer, conductors on two or more inner layers, conductors on two surface layers, or any combination thereof.

In addition to transferring current, electrical interconnect 620 can conduct thermal energy, as shown in FIG. 6. As discussed above, thermal energy typically flows in the direction on a conductor that leads to a cooler temperature. The inner layers of an operating laminated composite assembly 600 can be warmer than ambient air temperature and/or the temperature of a heat sink. As shown in FIG. 6, the thermal energy can flow from the inner layers of laminated composite assembly 600 to a surface layer for dissipation in the ambient air or heat sink. Varying the number of electrical interconnects 620 can alter the amount of thermal energy transferred to a surface layer. A designer can configure the laminated composite assembly to achieve a predetermined thermal profile by varying the size and number of electrical interconnects. Similarly stated, a designer can configure the laminated composite assembly to achieve a predetermined heat transfer path and/or profile.

While the only thermal energy transfer specifically depicted in laminated composite assembly 600 is electrical interconnect 620, other thermal energy heat transfer paths can be included in laminated composite assembly 600. For example, while electrical interconnect 620 can be a preferred path for transferring thermal energy, some thermal energy can be transferred through cores 630 and/or insulators 640, further dissipating thermal energy that flows on conductors 610. Similarly stated, thermal energy transfer through a core 630 and/or an insulator 640 can allow thermal energy to be dissipated from an electrically operative conductor of a layer to an electrically inoperative conductor of another layer while maintaining electrical isolation (i.e., the layers are not electrically coupled). The electrically inoperative conductors can transfer the thermal energy to an edge portion, a heat sink, and/or any other suitable heat dissipating element, as described with respect to FIGS. 1-5. Thermal energy transfer through a core 630 and/or an insulator 640 can similarly occur from an electrically operative conductor of a layer to an electrically operative conductor of another layer, from an electrically inoperative conductor of a layer to an electrically inoperative conductor of another layer, and/or from a conductor (either electrically operative or electrically inoperative) of a layer to a heat sink or other suitable heat dissipating element. Varying the heat transfer paths can allow a designer to optimize the thermal profile of laminated composite assembly 600.

In some embodiments, current can be induced in the conductors of the laminated composite assembly. For example, FIG. 7 is a schematic illustration of a cross-sectional view of a generator having a drive shaft 730, rotor segments 705 and 710, a stator 725, and magnets 715 and 720. The generator in FIG. 7 can be, for example, a wind turbine generator. In some embodiments, the laminated composite assemblies of FIGS. 1-6 can be a portion of a laminated composite assembly defining a machine winding in a stator (e.g., stator 725). Further details regarding generators and machine windings are provided in U.S. Pat. No. 7,109,625, issued Sep. 19, 2006, and entitled “Conductor Optimized Axial Field Rotary Energy Device,” which is incorporated herein by reference in its entirety.

In some embodiments, drive shaft 730 can be fixedly coupled to rotor segments 705, 710 (formed of a magnetically permeable material such as steel), and magnets 715, 720 can be fixedly coupled to rotor segments 705, 710. The end of drive shaft 730 that is not fixedly coupled to rotors 705, 710 can protrude through an opening of the generator housing. In some embodiments, the protruding end of drive shaft 730 can be coupled to an exterior device, such as blades of a wind turbine. When wind causes the blades of the wind turbine to move, drive shaft 730 rotates, causing rotor segments 705, 710 to rotate, in turn causing magnets 715, 720 to rotate.

Magnets 715, 720 can be rings that have poles N and S that alternate around the ring. In some embodiments, magnets 715, 720 can be made of individual segments. Magnets 715, 720 can be magnetic material including rare earth metals such as alloys of neodymium, iron, and/or boron. Magnets 715, 720 can have any even number of poles.

Stator 725 can be a laminated composite assembly, including a PCB, with conductive layers that are electrically coupled with electrical interconnects as described with respect to the previous figures.

In use, magnets 715 and 720 can be positioned so that an N pole on magnet 715 faces an S pole on magnet 720. The alternating magnetic poles of magnets 715, 720 generate a circumferentially alternating magnetic flux in the air gap formed between the rotor segments 705, 710, where the stator is located. A force (e.g., wind) can cause rotation of drive shaft 730 around the axis of rotation, which causes rotor segments 705, 710 to rotate with drive shaft 730, in turn causing magnets 715, 720 to rotate around drive shaft 730 (i.e., around the axis of rotation). The rotation of magnets 715, 720 causes the alternating magnetic flux to move with respect to the stator 725, which can induce an alternating voltage in the windings contained in stator 725 (e.g., the conductors of the laminated composite assembly).

In some embodiments, a current can be applied to stator 725, which can produce Lorentz forces between the flowing current and the magnetic field generated by magnets 715, 720. The resulting torque can cause magnets 715, 720 to rotate. The rotation of magnets 715, 720 can cause rotor segments 705, 710 to rotate, in turn causing drive shaft 730 to rotate. Thus, in some embodiments, the device in FIG. 7 can function as a motor rather than a generator.

In some embodiments, the laminated composite assemblies of FIGS. 1-6 can be a portion of a laminated composite assembly defining a machine winding in a stator (e.g., stator 725). Laminated composite assembly 600 can include radial portions on each layer and end turn portions on a subset of the layers. As discussed above, the current in the layers of laminated composite assembly 600 can be induced due to the magnets 715, 720 rotating around drive shaft 730.

FIG. 8A is a portion of a laminated composite assembly 800 having a first portion 820, a second portion 830, and a third portion 840 of conductor 810. FIG. 8B is a close-up view of the second portion 830 of the conductor 810 of FIG. 8A. Laminated composite assembly 800 can be structurally and functionally similar to laminated composite assembly 100 of FIG. 1. Laminated composite assembly 800 can have a first edge portion 870 and a second edge portion 880. Conductor 810 can be structurally and functionally similar to conductor 145 of FIG. 1.

The first portion 820 of conductor 810 can be structurally and functionally similar to the first portion 105 of conductor 145 of FIG. 1. For example, the first portion 820 of conductor 810 can be electrically operative. The first portion 820 of conductor 810 can have a first end portion 825. The first end portion 825 of the first portion 820 can be electrically and/or thermally coupled to the first end portion 850 of the second portion 830. The first end portion 825 of the first portion 820 can also be electrically and/or thermally coupled to the first end portion 860 of the third portion 840.

The second portion 830 of conductor 810 can be structurally and functionally similar to the second portion 110 of conductor 145 of FIG. 1. For example, the second portion 830 of conductor 810 can be electrically operative. As shown in FIGS. 8A and 8B, the second portion 830 can have a first end portion 850 and a second end portion 855. The end portions 850, 855 of the second portion 830 can be not at an edge portion 870, 880 of laminated composite assembly 800. Similarly stated, the end portions 850, 855 of the second portion 830 of conductor 810 can be at an inner portion of laminated composite assembly 800.

The second portion 830 of conductor 810 can taper such that the second end portion 855 of the second portion 830 of conductor 810 can have a width greater than a width of the first end portion 850 of the second portion 830 of conductor 810. Similarly stated, the second portion 830 of conductor 810 tapers from the second end portion 855 to the first end portion 850. Stated yet another way, the second portion 830 of conductor 810 widens from the first end portion 850 to the second end portion 855.

The second portion 830 of conductor 810 can be electrically segmented, as shown in FIGS. 8A and 8B. The second portion 830 of conductor 810 can have a first segment 832, a second segment 834, and a third segment 836. While three electrical segments of the second portion 830 of conductor 810 are shown in FIG. 8B, in some embodiments, the second portion 830 of conductor 810 can include fewer segments or a greater number of segments. Additionally, while the segments 832, 834, 836 of the second portion 830 are shown in FIGS. 8A and 8B as substantially the same size and shape, each segment 832, 834, 836 can be any suitable shape and/or size.

The third portion 840 of conductor 810 can be structurally and functionally similar to the third portion 115 of conductor 145 of FIG. 1. For example, the third portion 840 of conductor 810 can be electrically inoperative.

The third portion 840 can have a first end portion 860 and a second end portion 865. The first end portion 860 of the third portion 840 of conductor 810 can be disposed at an inner portion of laminated composite assembly 800. The second end portion 860 of the third portion 840 of conductor 810 can be disposed at a first edge portion 870 of laminated composite assembly 800. In some embodiments, the second end portion 865 of the third portion 840 can be thermally coupled to a heat sink and/or any other suitable heat dissipating element.

As shown in FIG. 8A, the third portion 840 of conductor 810 tapers from the first end portion 860 to the second end portion 865. Similarly stated, the first end portion 860 of the third portion 840 of conductor 810 has a width greater than a width of the second end portion 865 of the third portion 840 of conductor 810.

While FIGS. 8A and 8B depict a single layer, laminated composite assembly 800 can include multiple layers. In such embodiments, the second portion 830 can be electrically and/or thermally coupled to one or more conductors and/or one or more portions of conductors on one or more different layers using one or more electrical interconnects. The third portion 830 can also be electrically and/or thermally coupled to one or more conductors and/or one or more portions of conductors on one or more different layers.

In use, current “I” can be induced in and/or supplied to the conductor 810 and can flow in the direction shown in FIGS. 8A and 8B. Current “I” can flow through the first portion 820 of conductor 810. At the first end portion 825 of the first portion 820, current “I” can flow to the second portion 830 of conductor 810. In some embodiments, at the second end portion 855 of the second conductor 830, current can flow to different layers through one or more electrical interconnects (not shown in FIGS. 8A and 8B). Substantially no current “I” flows through the conductor 810 into the third portion 840 because the third portion 840 is electrically inoperative.

In some embodiments, current density increases in the second portion 830 near the second end portion 855 of the second portion 830 because multiple layers can be electrically coupled using electrical interconnects. Widening the second portion 830 at the second end portion 855 can optimize the performance of the conductor 810 with the increased current density.

As described above, an alternating magnetic field can induce current “I” in conductor 810. The alternating magnetic field can also induce eddy currents in conductor 810. The eddy currents in the second portion 830 can be mitigated or reduced because the second portion 830 is segmented. Varying the size and/or number of the first, second, and third segments 832, 834, 836 can further reduce the eddy currents in the second portion 830. Additionally, eddy currents can be similarly reduced in the first portion 820 and/or the third portion 840 by segmenting the first portion 820 and/or the third portion 840, respectively.

The operating circuit can generate heat, and thermal energy can also flow on conductor 810. The thermal energy can flow through the first portion 820 of conductor 810. At the first end portion 825 of the first portion 820 the thermal energy can flow to the first end portion 860 of the third portion 840. The thermal energy can flow through the third portion 840 to the first edge portion 870 of laminated composite assembly 800 to dissipate in the ambient air or to the heat sink, as described above. The third portion 840 can taper toward the second end portion 865 because the third portion 840 of conductor 810 carries substantially no useful current and thus has a low current density.

While described with respect to FIG. 8 as using direct current (DC), alternating current (AC) can also be used in laminated composite assembly 800, as described above.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above.

1. An apparatus, comprising:
a first portion of an electrical conductor of a laminated composite assembly;
a second portion of the electrical conductor electrically coupled to the first portion of the electrical conductor; and
a third portion of the electrical conductor electrically coupled to the first portion of the electrical conductor and the second portion of the electrical conductor, the first portion, the second portion and the third portion are configured such that substantially no current provided to the first portion is conducted to the third portion of the electrical conductor, the third portion of the electrical conductor being thermally coupled to the first portion of the electrical conductor and the second portion of the electrical conductor, the third portion of the electrical conductor configured to transfer thermal energy from the first portion of the electrical conductor to an edge portion of the laminated composite assembly.

2. The apparatus of claim 1, wherein the first portion, the second portion and the third portion are configured such that current provided to the first portion of the electrical conductor is conducted to the second portion of the electrical conductor.

3. The apparatus of claim 1, wherein the third portion of the electrical conductor is electrically coupled to the first portion of the electrical conductor via an electrical interconnect.

4. The apparatus of claim 1, wherein the first portion of the electrical conductor is disposed on a first layer of the laminated composite assembly, the third portion of the electrical conductor is disposed on a second layer of the laminated composite assembly different from the first layer of the laminated composite assembly.

5. The apparatus of claim 1, wherein the at least one of the first portion or the second portion of the electrical conductor includes at least one of an end turn of a machine winding, a power distribution conductor or an internal bus bar.

6. The apparatus of claim 1, wherein the first portion, the second portion and the third portion are configured such that substantially no current is applied to the third portion of the electrical conductor.

7. An apparatus, comprising:
a first conductor of a laminated composite assembly, the first conductor configured to be electrically operative; and
a plurality of second conductors of the laminated composite assembly, each second conductor from the plurality of second conductors being electrically isolated from the first conductor, each second conductor from the plurality of second conductors configured to be electrically inoperative, each second conductor from the plurality of second conductors being electrically isolated from each remaining second conductor from the plurality of second conductors to substantially reduce formation of eddy currents on the plurality of second conductors.

8. The apparatus of claim 7, wherein each second conductor from the plurality of second conductors is electrically isolated from a source current.

9. The apparatus of claim 7, further comprising:
a plurality of third conductors of the laminated composite assembly, each third conductor from the plurality of third conductors configured to be electrically inoperative, the plurality of second conductors being on a first layer of the laminated composite assembly, the plurality of third conductors being on a second layer of the laminated composite assembly,
at least one second conductor from the plurality of second conductors being electrically coupled to at least one third conductor from the plurality of third conductors via an electrical interconnect such that thermal energy is configured to be transferred between the at least one second conductor and the at least one third conductor via the electrical interconnect.

10. The apparatus of claim 7, wherein the first conductor includes at least one of an end turn of a machine winding, a power distribution conductor or an internal bus bar.

11. The apparatus of claim 7, wherein each second conductor from the plurality of second conductors is arranged in a predetermined pattern with the remaining second conductors from the plurality of second conductors.

12. The apparatus of claim 7, wherein each second conductor from the plurality of second conductors has a shape similar to a shape of each remaining second conductor from the plurality of second conductors.

13. The apparatus of claim 7, wherein each second conductor from the plurality of second conductors has a shape configured to transfer thermal energy to an edge portion of the laminated composite assembly.

14. An apparatus, comprising:
a first surface layer from a plurality of layers of a laminated composite assembly;
a second surface layer from the plurality of layers of the laminated composite assembly; and
at least one inner layer from the plurality of layers of the laminated composite assembly, the at least one inner layer being disposed between the first surface layer and the second surface layer, the at least one inner layer having at least one conductor thermally coupled to at least a portion of the first surface layer and at least a portion of the second surface layer via an electrical interconnect such that thermal energy at the at least one conductor of the at least one inner layer is configured to be transferred to the first surface layer and the second surface layer to achieve a predetermined thermal profile.

15. The apparatus of claim 14, wherein the portion of the first surface layer, the portion of the second surface layer and the at least one conductor of the at least one inner layer are configured to be electrically inoperative.

16. The apparatus of claim 14, wherein the portion of the first surface layer, the portion of the second surface layer and the at least one conductor of the at least one inner layer are configured to not carry a useful current.

17. The apparatus of claim 14, wherein the electrical interconnect is at least one of a plated electrical interconnect defining a lumen having a non-conductive material disposed therein, a plated electrical interconnect defining a lumen having a conductive material disposed therein, a solid electrical interconnect or a pressed pin electrical interconnect.

18. The apparatus of claim 14, wherein the at least one conductor of the at least one inner layer is electrically coupled to at least one of an end turn of a machine winding, a power distribution conductor or an internal bus bar.

19. The apparatus of claim 14, wherein the at least one conductor of the at least one inner layer is a first conductor of the at least one inner layer, the first conductor being electrically isolated from a second conductor of the at least one inner layer, the second conductor being electrically coupled to a current source.

20. The apparatus of claim 14, wherein the thermal energy at the at conductor of the at least one inner layer is generated at the at least one inner layer.

21. The apparatus of claim 14, further comprising:
a magnet, the thermal energy at the at least one conductor of the at least one inner layer being generated in response to the magnet moving with respect to the laminated composite assembly.

22. The apparatus of claim 14, wherein the first surface layer includes at least one conductor, the second surface layer including at least one conductor, the at least one conductor of the at least one inner layer being electrically coupled to the at least one conductor of the first surface layer and the at least one conductor of the second surface layer via the electrical interconnect.
